(19) United States
(12) Patent Application Publication
(10) Pub. No.: US 2008/0052173 A1
(43) Pub. Date: Feb. 28, 2008

(54) FAST FOOD WRAPPING AND DELIVERY SYSTEM AND METHOD FOR THE SAME

(76) Inventor: Mei-Lin Liou, Richmond (CA)

Correspondence Address: NORTH AMERICA INTELLECTUAL PROPERTY CORPORATION, P.O. BOX 506, MERRIFIELD, VA, 22116, US

(21) Appl. No.: 11/557,490

(22) Filed: Nov. 7, 2006

Related U.S. Application Data
(60) Provisional application No. 60/823,759, filed on Aug. 28, 2006.

(51) Int. Cl. G06Q 50/00

(52) U.S. Cl. 705/15

(57) ABSTRACT

The fast food wrapping and delivery method and system use an ink jet printer that can print patterns in either obverse form and reverse form to print a food order and nutrition information of a food on a food container in real-time. When a POS system receives the food order from a customer, the POS system controls the ink jet printer to print the food order (or plus some additional instructions for making a food and nutrition information of the food) on one side of the food container to generate a custom fabricated food container that best fits with each unique food product ordered by a customer.

### CROSS REFERENCE TO RELATED APPLICATIONS

This application claims the benefit of the filing date of U.S. provisional patent application No. 60/823,759, filed Aug. 28, 2006, the contents of which are hereby incorporated by reference.

### BACKGROUND OF THE INVENTION

1. Field of the Invention

The present invention relates to a wrapping and delivery system and method, and more specifically, to a system and method for fast food wrapping and delivery.

2. Description of the Prior Art

The manufacturing process of food has being systematically developing in the fast food industries. A counter in the front stage receives an order from a customer and inputs the order into a point of service (POS) system, which can send order information to the backstage kitchen workers. The kitchen workers in the backstage then make foods according to the order from the POS system and wrap the foods in wrappers when foods are done. The wrapped foods are delivered to the counter and handed over to the customer.

A prior art food wrapper in some fast food industries has prefabricated pattern indicating a food that should be wrapped inside. The prefabricated pattern is printed on one side of the wrapper while the other side of the wrapper is for directly contacting and wrapping the food so that the food is not contaminated by the prefabricated pattern. The kitchen workers then pick a right wrapper according to the prefabricated pattern on the wrapper for wrapping the right food inside. But using wrappers with prefabricated pattern to wrap the foods is limited in the variety of food that can be wrapped and the efficiency of the procedure of delivering foods with wrappers can be lowered down since the wrappers are not easily identifiable from the other side that directly contacting and wrapping the food.

For another kind of wrapper in the prior art, which is plain and translucent, kitchen workers have to wrap the food in the wrapper and deliver the foods carefully in organized way. Even so, foods wrapped with the same wrappers are still highly possible to be mistakenly wrapped and delivered to a customer, which deteriorates the service quality of a fast food industry.

### SUMMARY OF THE INVENTION

The claimed invention provides a fast food wrapping and delivery system. The system comprises a food container having a first side and a second side for wrapping a food with the second side, a control device for receiving a food order, and a printer for printing the food order on the first side of the food container.

The claimed invention further provides a method for wrapping and delivering a fast food. A printer connected with a control device prints a food order on a food container having a first side and a second side for wrapping a food. The method comprises inputting the food order into the control device, printing the food order on the first side of the food container, and wrapping the food in the food container with the second side.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of a method for fast food wrapping and delivery according to the present invention.

FIG. 2 is an illustration of a system for fast food wrapping and delivery according to the present invention.

FIG. 3 is an illustration of an exemplary embodiment of a food container having patterns printed on one side using the method of the present invention.

### DETAILED DESCRIPTION

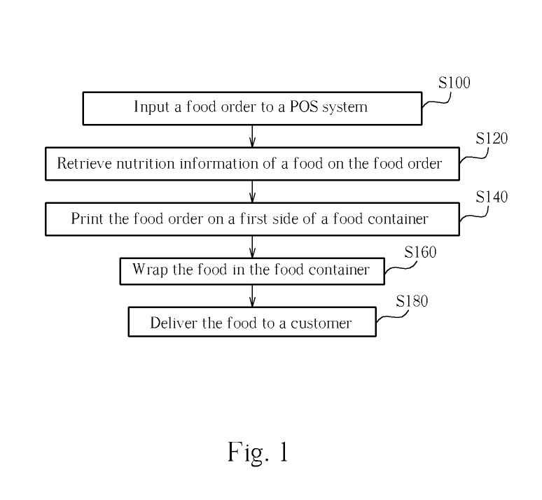

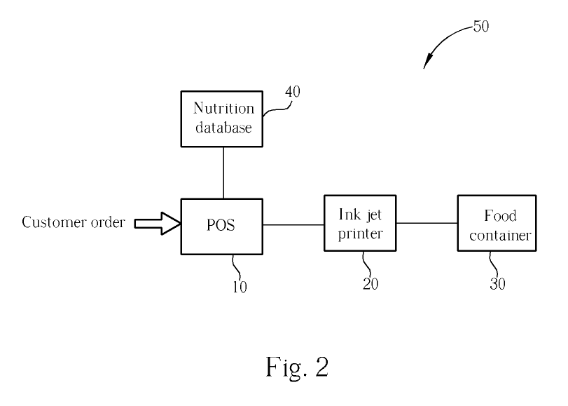

FIG. 1 is a flow chart of a method for fast food wrapping and delivery according to the present invention. FIG. 2 illustrates a fast food wrapping and delivery system 50 for realizing the method of the present invention. The method includes the following steps:

Step S100: Input a food order to a POS system 10; the food order is from a customer and includes additional instructions for making a food;

Step S120: Retrieve nutrition information of the food on the food order from a nutrition database 40;

Step S140: Control an ink jet printer 20 to print the food order (including additional instructions for making the food and nutrition information of the food) on a first side of a food container 30;

Step S160: Select the food corresponding to the food order printed on the first side of the food container 30 and wrap the food in the food container 30 with the second side of the food container 30;

Step S180: Deliver the food wrapped with the food container 30 to the customer.

When a customer makes an order at the counter, the order is inputted to the POS system 10 (Step S100), which connects with the nutrition database 40 and the ink jet printer 20. If there is any additional requirement for making the food from the customer, the requirement is also inputted to the POS system 10 as instructions for making the food. The POS system 10 can retrieve relevant nutrition information of the food in the order from the nutrition database 40 (Step S120). Meanwhile, the order inputted to the POS system 10 is transmitted directly to the ink jet printer 20 for printing the food order (plus nutrition information and the instructions for making the food) on the food container 30 or to the kitchen workers in the backstage to control the ink jet printer 20 for printing on the food container 30. Thus, the method and the system 50 allow a fast food wrapping procedure with real-time custom food container manufacture.

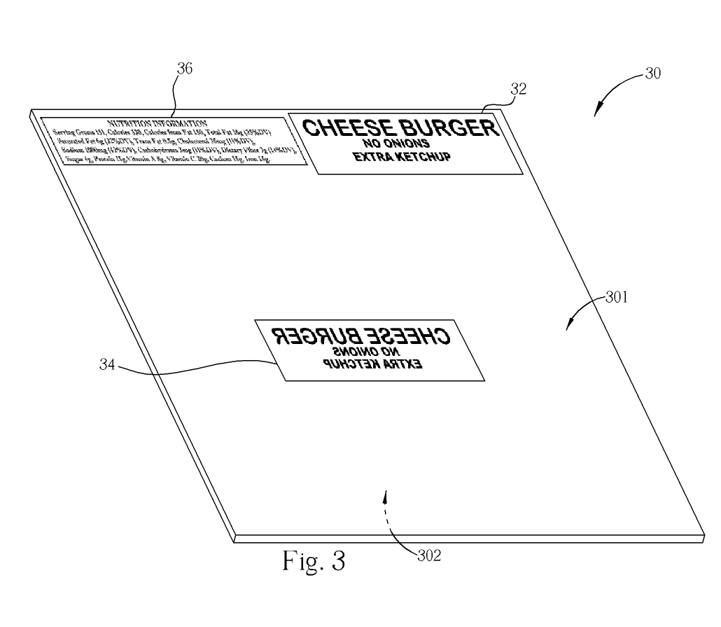

Additionally, the ink jet printer 20 used in the method and the system 50 of the present invention is capable of outputting patterns in both obverse form and reverse form. Please refer to FIG. 3. FIG. 3 is an illustration of an exemplary embodiment of the food container 30 having patterns printed on one side using the method of the present invention. The food container 30 can be a wrapper, a box, a bag, or any container that has one side capable of being printed with patterns and the other side for wrapping a food. The method and the system 50 can also apply a translucent food container 30 for a more efficient and accurate food wrapping and delivery process because of the advantage that the kitchen workers can easily recognize what kind of food should be wrapped in the food container 30 by viewing the printed patterns on the first side of the food container 30 from the second side of the food container 30 and wrap the right food with the second side of the food container 30. For example, the food container 30 in FIG. 3 comprises a first side 301 and a second side 302 wherein the first side 301 comprises a first pattern 32, a second pattern 34, and a nutrition information pattern 36. The first pattern 32 includes the food order (along with instructions for making the food) from the POS system 10 in obverse form and the second pattern 34 includes the food order (along with instructions for making the food) in reverse form. Both the first and the second patterns are printed on the first side 301 of the food container 30. Since the food container 30 is translucent, the first and the second patterns 32, 34 are visible from the second side 302 of the food container 30, which indicates that the first pattern 32 is in reverse form if viewed from the second side 302 of the food container 30 and the second pattern 34 is in obverse form if viewed from the second side 302 of the food container 30.

In the exemplary embodiment in FIG. 3, the second pattern 34 is the reverse form of the first pattern 32, i.e., the reverse form of the food order from the POS system 10. But the second pattern 34 need not necessarily be exactly the reverse form of the first pattern 32 and can be another pattern that is friendlier to the customer. The method of the present invention also prints nutrition information of the food to be wrapped inside as the nutrition information pattern 36 on the first side 301 of the food container 30.

Next, the kitchen workers in the backstage can select the right food and wrap the food in the custom fabricated food container 30 with the second side 302 of the food container 30 and thereby the content of the product is recognizable from the first side 301 the food container 30.

The fast food wrapping and delivery method and system of the present invention use an ink jet printer that can print patterns in either obverse form and reverse form to print a food order and nutrition information of a food on a food container in real-time. When a POS system receives the food order from a customer, the POS system controls the ink jet printer to print the food order (or plus some additional instructions for making a food and nutrition information of the food) on one side of the food container to generate a custom fabricated food container that best fits with each unique food product ordered by a customer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fast food wrapping and delivery system, comprising:
a food container having a first side and a second side for wrapping a food with the second side;
a control device for receiving a food order; and
a printer for printing the food order on the first side of the food container.

2. The system of claim 1, further comprising a nutrition database connecting with the control device for sending nutrition information corresponding to food order to the control device.

3. The system of claim 2, wherein the control device is further for controlling the printer to print the nutrition information on the first side of the food container.

4. The system of claim 1, wherein the printer is connected with the control device for receiving the food order from the control device.

5. The system of claim 1, wherein the food container is a wrapper, a box, or a bag.

6. The system of claim 1, wherein the food container is translucent.

7. The system of claim 1, wherein the control device is a point of service (POS) system.

8. The system of claim 1, wherein the control device is further for controlling the printer to print a first pattern in obverse form and a second pattern in reverse form on the first side of the food container, the first pattern and the second pattern being corresponding to the food order.

9. The system of claim 1, wherein the control device is further for receiving the food order having instructions for making the food.

10. The system of claim 1, wherein the printer is an ink jet printer capable of printing the food order in obverse form and in reverse form on the first side of food container.

11. A method for wrapping and delivering a fast food, a printer connected with a control device printing a food order on a food container having a first side and a second side for wrapping a food, the method comprising:
inputting the food order into the control device;
printing the food order on the first side of the food container; and
wrapping the food in the food container with the second side.

12. The method of claim 11, the control device being a point of service (POS) system, the method further comprising retrieving nutrition information of the food from a nutrition database connected with the POS system.

13. The method of claim 12, further comprising printing the nutrition information on the first side of the food container.

14. The method of claim 11, wherein printing the food order on the first side of the food container comprises printing a first pattern in obverse form and a second pattern in reverse form on the first side of the food container, the first pattern and the second pattern being corresponding to the food order.

15. The method of claim 11, wherein inputting the food order into the control device comprises inputting the food order having instructions for making the food.
